(19) United States
(12) Patent Application Publication
(10) Pub. No.: US 2013/0009474 A1
(43) Pub. Date: Jan. 10, 2013

(54) FAST-DISCHARGING CIRCUIT

(75) Inventors: JIN-LIANG XIONG, Shenzhen City (CN); YI-XIN TU, Shenzhen City (CN); HAI-QING ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/411,611

(22) Filed: Mar. 4, 2012

(30) Foreign Application Priority Data
Jul. 7, 2011 (CN) 201110189536.9

(51) Int. Cl. H02J 1/10

(52) U.S. Cl. 307/43

(57) ABSTRACT

A fast-discharge circuit includes at least one power supply group, a switch circuit, and a power connector. Each power supply group includes a power supply unit, stabilizing capacitances, a diode, and a resistance. The power supply unit includes a positive output and a negative output. Anodes of the stabilizing capacitances and the diode are connected to the positive output of the power supply unit. Cathodes of the stabilizing capacitances are connected to the negative output. A cathode of the diode is also connected to the negative output through the resistance. The switch circuit includes a NMOS transistor. A drain of the NMOS transistor is electrically connected to the negative outputs of each power supply; a source of the NMOS transistor is grounded. The power connector includes a PS-ON pin electrically connected to a gate of the NMOS transistor.

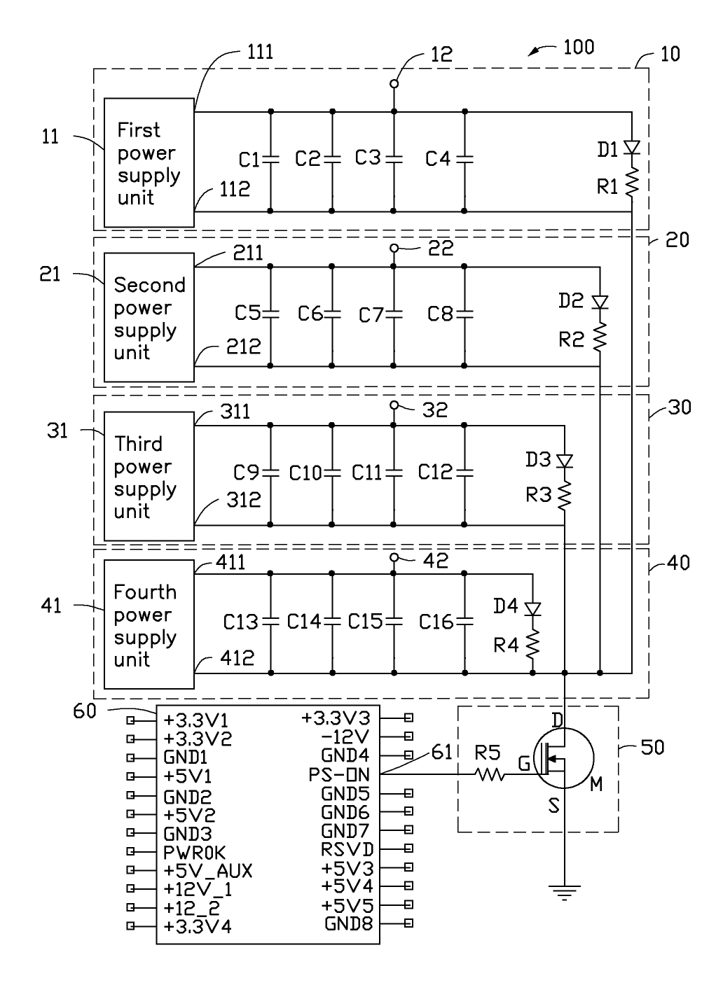

### BACKGROUND

1. Technical Field

The disclosure relates to a fast-discharging circuit.

2. Description of Related Art

In a computer motherboard, the s itch circuit s configured to output 5V, 3.3V, and 12V through a DC-DC circuit into low-voltage high-current power supply for each different unit or chip. However, fast rebooting of a computer motherboard after a shutdown is difficult to achieve. The main reason is that low-voltage high-current power outputs of the DC-DC circuit need to establish connections to a lot of stabilizing capacitances in parallel, which results slow discharging or the generating of timing errors. A method for solving the problem is to connect each stabilizing capacitance to a resistance to speed up the discharge of every stabilizing capacitance. Although his method can solve slow discharge problem, the resistances are energy-consuming components and will lead to energy loss, which is not environmentally protective.

Therefore, it is desired to provide a discharging circuit to overcome the above-described problem.

### BRIEF DESCRIPTION OF THE DRAWINGS

Many aspects of the present disclosure can be better understood with reference to the drawing. The components in the drawing are not necessarily drawn to scale, the emphasis instead being placed upon clearly illustrating the principles of the present disclosure.

The drawing is a schematic view of a fast-discharging circuit, according to an exemplary embodiment.

### DETAILED DESCRIPTION

Embodiments of the disclosure will be described in detail with reference to the drawing.

Referring to the drawing, a fast-discharging circuit 100, according to an exemplary embodiment, is used for discharging power from a computer system. The fast-discharging circuit 100 includes a first power supply group 10, a second power supply group 20, a third power supply group 30, a fourth power supply group 40, a switch circuit 50, and a power connector 60.

The first power supply group 10, the second power supply group 20, the third power supply group 30, and the fourth power supply group 40 are all connected to the switch circuit 50 in parallel. The switch circuit 50 is also connected to the power connector 60.

The first power supply group 10 includes a first power supply unit 11, a first stabilizing capacitance C1, a second stabilizing capacitance C2, a third stabilizing capacitance C3, a fourth stabilizing capacitance C4, a first diode D1, and a first resistance R1. The first power supply unit 11 includes a first positive output 111 and a first negative output 112. Anodes of the first stabilizing capacitance C1, the second stabilizing capacitance C2, the third stabilizing capacitance C3, the fourth stabilizing capacitance C4 and the first diode D1 all are electrically connected to the first positive output 111. Cathodes of the first stabilizing capacitance C1, the second stabilizing capacitance C2, the third stabilizing capacitance C3 and the fourth stabilizing capacitance C4 all are electrically connected to the first negative output 112. The cathode of the first diode D1 is also electrically connected to the first negative output 112 through the first resistance R1. The first power supply group 10 also includes a first power output 12 for outputting power for a CPU. In the embodiment, the first power output 12 is electrically connected to the anode of the third capacitance C3.

The second power supply group 20 includes a second power supply unit 21, a fifth stabilizing capacitance C5, a sixth stabilizing capacitance C6, a seventh stabilizing capacitance C7, an eighth stabilizing capacitance C8, a second diode D2, and a second resistance R2. The second power supply unit 21 includes a second positive output 211 and a second negative output 212. Anodes of the fifth stabilizing capacitance C5, the sixth stabilizing capacitance C6, the seventh stabilizing capacitance C7, the eighth stabilizing capacitance C8 and the second diode D2 are all electrically connected to the second positive output 211. Cathodes of the fifth stabilizing capacitance C5, the sixth stabilizing capacitance C6, the seventh stabilizing capacitance C7, the eighth stabilizing capacitance C8 all are electrically connected to the second negative output 212. The cathode of the second diode D2 is also electrically connected to the second negative output 212 through the second resistance R2. The second power supply group 20 also includes a second power output 22 for outputting power for a Northbridge chip. In particular, the second power output 22 is electrically connected to the anode of the seventh capacitance C7.

The third power supply group 30 includes a third power supply unit 31, a ninth stabilizing capacitance C9, a tenth stabilizing capacitance C10, an eleventh stabilizing capacitance C11, a twelfth stabilizing capacitance C12, a third diode D3, and a third resistance R3. The third power supply unit 31 includes a third positive output 311 and a third negative output 312. Anodes of the ninth stabilizing capacitance C9, the tenth stabilizing capacitance C10, the eleventh stabilizing capacitance C11, the twelfth stabilizing capacitance C12 and the third diode D3 all are electrically connected to the third positive output 311. Cathodes of the ninth stabilizing capacitance C9, the tenth stabilizing capacitance C10, the eleventh stabilizing capacitance C11, the twelfth stabilizing capacitance C12 are all electrically connected to the third negative output 312. The cathode of the third diode D3 is also electrically connected to the third negative output 312 through the third resistance R3. The third power supply group 30 also includes a third power output 32 for outputting power for a Southbridge chip. In particular, the third power output 32 is electrically connected to the anode of the eleventh capacitance C11.

The fourth power supply group 40 includes a fourth power supply unit 41, a thirteenth stabilizing capacitance C13, a fourteenth stabilizing capacitance C14, a fifteenth stabilizing capacitance C15, a sixteenth stabilizing capacitance C16, a fourth diode D4, and a fourth resistance R4. The fourth power supply unit 41 includes a fourth positive output 411 and a fourth negative output 412. Anodes of the thirteenth stabilizing capacitance C13, the fourteenth stabilizing capacitance C14, the fifteenth stabilizing capacitance C15, the sixteenth stabilizing capacitance C16 and the fourth diode D4 are all electrically connected to the fourth positive output 411. Cathodes of the thirteenth stabilizing capacitance C13, the fourteenth stabilizing capacitance C14, the fifteenth stabilizing capacitance C15 and the sixteenth stabilizing capacitance C16 are all electrically connected to the fourth negative output 412. The cathode of the fourth diode D4 is also electrically connected to the fourth negative output 412 through the fourth resistance R4. The fourth power supply group 40 also includes a fourth power output 42 for outputting a power supply for a system. In particular, the fourth power output 42 is electrically connected to the anode of the fifteenth stabilizing capacitance C15.

The switch circuit 50 includes a transistor M and a split-voltage resistance R5. In the embodiment, the transistor M is a NMOS transistor. A drain D of the NMOS transistor M is electrically connected to the first negative output 112, the second negative output 212, the third negative output 312, and the fourth negative output 412. A source S of the NMOS transistor M is grounded.

The power connector 60 is a male connector, which includes a PS-ON pin 61. The PS-ON pin 61 is electrically connected to a gate G of the NMOS transistor M through the fifth resistance R5.

The fast-discharging circuit 100 can include only the first power supply group 10, or the second power supply group, or the third power supply group 30, or the fourth power supply group 40.

In the embodiment, a logical high “1” (high level voltage) is 5V and a logical low “0” (low level voltage) is 0V.

When the fast-discharging circuit 100 works in normal operation, the PS-ON pin 61 of the power connector 60 outputs a low level voltage. As such, the NMOS transistor M shuts off. At the same time, the first power supply unit 11 provides a working voltage, after the first, second, third, fourth stabilizing capacitances C1, C2, C3, and C4 are stabilized, the working voltage is output by the first power output 12; the second power supply unit 21 provides a working voltage, after the fifth, sixth, seven, eighth stabilizing capacitances C5, C6, C7, and C8 are stabilized, the working voltage is output by the second power output 22; the third power supply unit 31 provides a working voltage, after the ninth, tenth, eleventh, twelfth stabilizing capacitances C9, C10, C11, and C12 are stabilized, the working voltage is output by the third power output 32; the fourth power supply unit 41 provides a working voltage, after the thirteenth, fourteenth, fifteenth, sixteenth stabilizing capacitances C13, C14, C15, and C16 are stabilized, the working voltage is output by the fourth power output 42. In this situation, because the NMOS transistor M shuts off, the first, second, third, and fourth resistances R1, R2, R3 and R4 do not work, therefore meeting as far as possible environmental concerns.

During the process of the fast-discharging circuit 100 being restarted, the first, second, third, and fourth power supply units 11, 21, 31, and 41 stop outputting the working voltage. The PS-ON pin 61 of the power connector 60 outputs a high level voltage. As such, the NMOS transistor M turns on. At the same time, the first, second, third, fourth stabilizing capacitances C1, C2, C3, and C4 begin to discharge, and the residual power is led to ground through the first diode D1, the first resistance R1 and the NMOS transistor M; the fifth, sixth, seven, eighth stabilizing capacitances C5, C6, C7, and C8 begin to discharge, and are led to ground through the second diode D2, the second resistance R2 and the NMOS transistor M; the ninth, tenth, eleventh, twelfth stabilizing capacitances C9, C10, C11, and C12 begin to discharge, and are grounded through the third diode D3, the third resistance R3 and the NMOS transistor M; the thirteenth, fourteenth, fifteenth, sixteenth stabilizing capacitances C13, C14, C15, and C16 begin to discharge, and are led to ground through the fourth diode D4, the fourth resistance R4 and the NMOS transistor M, to speed up the discharge of every stabilizing capacitance.

While certain embodiments have been described and exemplified above, various other embodiments will be apparent to those skilled in the art from the foregoing disclosure. The disclosure is not limited to the particular embodiments described and exemplified, and the embodiments are capable of considerable variation and modification without departure from the scope of the appended claims.

What is claimed is:

1. A fast-discharging circuit, comprising:
at least one power supply group, each power supply group comprising a power supply unit, a plurality of stabilizing capacitances, a diode, and a resistance, the power supply unit comprising a positive output and a negative output, anodes of the stabilizing capacitances and the diode being respectively connected to the positive output of the power supply unit, cathodes of the stabilizing capacitances being respectively connected to the negative output of the power supply unit, a cathode of the diode being connected to the negative output of the power supply unit through the resistance;
a switch circuit comprising a NMOS transistor, a drain of the NMOS transistor being electrically connected to the negative output of each power supply unit, a source of the NMOS transistor being grounded; and
a power connector comprising a PS-ON pin electrically connected to a gate of the NMOS transistor;
wherein when the discharging circuit works in normal operation, the PS-ON pin of the power connector outputs a low level voltage, the NMOS transistor shuts off, during the process of the discharging circuit being restarted, the PS-ON pin outputs a high level voltage, the NMOS transistor turns on.

2. The fast-discharging circuit of claim 1, wherein the at least one power supply group comprises a first power supply group for outputting a power supply for a CPU, the first power supply group comprises a first power supply unit, a first stabilizing capacitance, a second stabilizing capacitance, a third stabilizing capacitance, a fourth stabilizing capacitance, a first diode, and a first resistance, the first power supply unit comprises a first positive output and a first negative output, anodes of the first, second, third, and fourth stabilizing capacitances and the first diode are all electrically connected to the first positive output, cathodes of the first, second, third, and fourth stabilizing capacitances are all electrically connected to the first negative output, a cathode of the first diode is also electrically connected to the first negative output through the first resistance.

3. The fast-discharging circuit of claim 2, wherein the first power supply group further comprises a first power output for outputting the power supply for the CPU.

4. The fast-discharging circuit of claim 3, wherein the first power output is electrically connected to the anode of the third capacitance.

5. The fast-discharging circuit of claim 2, wherein the at least one power supply group further comprises a second power supply group for outputting a power supply for a Northbridge chip, the second power supply group comprises a second power supply unit, a fifth stabilizing capacitance, a sixth stabilizing capacitance, a seventh stabilizing capacitance, an eighth stabilizing capacitance, a second diode, and a second resistance, the second power supply unit comprises a second positive output and a second negative output, anodes of the fifth, the sixth, the seventh, the eighth stabilizing capacitances and the second diode are all electrically connected to the second positive output, cathodes of the fifth, the sixth, the seventh, the eighth stabilizing capacitances are all electrically connected to the second negative output, a cathode of the second diode is also electrically connected to the second negative output through the second resistance.

6. The fast-discharging circuit of claim 5, wherein the second power supply group further comprises a second power output for outputting the power supply for the Northbridge chip.

7. The fast-discharging circuit of claim 6, wherein the second power output is electrically connected to the anode of the seventh capacitance.

8. The fast-discharging circuit of claim 5, wherein the at least one power supply group further comprises a third power supply group for outputting a power supply for a Southbridge chip, the third power supply group comprises a third power supply unit, a ninth stabilizing capacitance, a tenth stabilizing capacitance, an eleventh stabilizing capacitance , a twelfth stabilizing capacitance, a third diode, and a third resistance, the third power supply unit comprises a third positive output and a third negative output, anodes of the ninth, the tenth, the eleventh, the twelfth stabilizing capacitances and the third diode are all electrically connected to the third positive output, cathodes of the ninth, the tenth, the eleventh, the twelfth stabilizing capacitances are all electrically connected to the third negative output, a cathode of the third diode is also electrically connected to the third negative output through the third resistance.

9. The fast-discharging circuit of claim 8, wherein the third power supply group further comprises a third power output for outputting the power supply for the Southbridge chip.

10. The fast-discharging circuit of claim 9, wherein the third power output is electrically connected to the anode of the eleventh capacitance.

11. The fast-discharging circuit of claim 8, wherein the at least one power supply group further comprises a fourth power supply group for outputting a power supply for a system, the fourth power supply group comprises a fourth power supply unit, a thirteenth stabilizing capacitance, a fourteenth stabilizing capacitance, a fifteenth stabilizing capacitance, a sixteenth stabilizing capacitance, a fourth diode, and a fourth resistance, the fourth power supply unit comprises a fourth positive output and a fourth negative output, anodes of the thirteenth, the fourteenth, the fifteenth, the sixteenth stabilizing capacitances and the fourth diode are all electrically connected to the fourth positive output, cathodes of the thirteenth, the fourteenth, the fifteenth, the sixteenth stabilizing capacitances are all electrically connected to the fourth negative output, a cathode of the fourth diode is also electrically connected to the fourth negative output through the fourth resistance.

12. The fast-discharging circuit of claim 11, wherein the fourth power supply group further comprises a fourth power output for outputting the power supply for the system.

13. The fast-discharging circuit of claim 12, wherein the fourth power output is electrically connected to the anode of the fifteenth stabilizing capacitance.

14. The fast-discharging circuit of claim 1, wherein the switch circuit further comprises a split-voltage resistance, the PS-ON pin is electrically connected to the gate of the NMOS transistor through the fifth resistance.

15. The fast-discharging circuit of claim 1, wherein the power connector is a male connector.
